(19) United States
(12) Patent Application Publication
(10) Pub. No.: US 2025/0344829 A1
(43) Pub. Date: Nov. 13, 2025

(54) POWDER BLOWING APPLICATOR GUN

(71) Applicant: True Glow Spray Tan, LLC, Atlanta, GA (US)

(72) Inventor: Julie McGee Stadtfeld, Atlanta, GA (US)

(21) Appl. No.: 19/202,276

(22) Filed: May 8, 2025

Related U.S. Application Data
(60) Provisional application No. 63/565,085, filed on May 10, 2024.

(51) Int. Cl. A45D 33/02; B05B 7/14

(52) U.S. Cl. CPC A45D 33/02; B05B 7/1413; B05B 7/1486

(57) ABSTRACT

An apparatus for applying drying powder after a spray tan may comprise a main body configured to receive pressurized air from an air source. The apparatus may include a powder reservoir attached to the main body and configured to hold drying powder. An internal channel within the main body may be configured to direct air flow from the external air source to the powder reservoir. The apparatus may have a nozzle attached to the main body and configured to deliver a mixture of air and drying powder. A trigger mechanism may be configured to control air flow through the internal channel.

### RELATED APPLICATION

Under provisions of 35 U.S.C. § 119 (e), the Applicant claims benefit of U.S. Provisional Application No. 63/565,085 filed on May 10, 2024, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to cosmetic application devices. More specifically, the disclosure pertains to apparatus for applying powder products to the skin in a controlled and efficient manner following spray tanning treatments.

### BACKGROUND

Conventional spray tanning processes may require additional steps to complete the tanning procedure. For example, after applying the spray tan solution, clients may need to wait for an extended period to allow the solution to dry completely. Thus, the conventional strategy may be to use manual methods to apply drying powder to the skin. This often causes problems because the conventional strategy may not provide consistent coverage or efficient application of the drying powder. For example, using brushes or other manual applicators to apply drying powder may result in uneven distribution and may take a significant amount of time to cover the entire body.

Furthermore, traditional methods of powder application in spray tanning may raise hygiene concerns. The use of brushes or other applicators that come into direct contact with the skin may potentially transfer bacteria or other contaminants between clients if not properly sanitized.

The time-consuming nature of conventional powder application methods may also impact the overall efficiency of spray tanning services. Clients may need to spend additional time in the tanning booth, room, or salon to allow for the manual powder application process, which may limit the number of clients that can be served in a given time period.

Moreover, the inconsistency in powder application using traditional methods may affect the final results of the spray tan. Areas with excess powder may appear lighter or patchy, while areas with insufficient powder may remain tacky or prone to smudging. This variability in results may lead to customer dissatisfaction and the need for touch-ups or reapplication.

In addition to the issues mentioned previously, conventional spray tanning processes may face challenges related to client comfort and satisfaction. For example, the extended waiting time required for the tanning solution to dry completely may lead to client discomfort. This waiting period may also increase the likelihood of the tanning solution transferring onto clothing or other surfaces, potentially causing stains and/or uneven results.

Furthermore, the manual application of drying powder may not adequately address the issue of skin tackiness in hard-to-reach areas, areas that clients may be uncomfortable with others touching (even with a brush), or areas that may be unsanitary to touch with a brush, such as (but not limited to) the back or between fingers and toes. This may result in an uncomfortable feeling for clients and may affect the overall quality of the spray tan.

The tanning industry has seen creative alternatives to brush application of powder, avoiding the need to actually touch the powder brush to those areas of the body. In one alternative, powder may be applied to the brush, and then an air hose (e.g., the air hose used with the spray tan applicator) may be used to blow the powder on the powder brush to those areas of the body. While this eliminates the direct contact, it is still extremely time consuming and will not yield a perfectly applied even layer of powder.

Another creative method of applying drying powder after spray tan application involves use of a ‘squeeze ball pump’ or other air powder blowers that need manual activation. For example, the squeeze ball pump requires a consistent squeezing of the ball to create an outward force of air and powder mix. This method helps to create an even application of powder, but takes just as much time as manual powder application due to the lack of consistent air flow. Moreover, the constant squeezing can be onerous, particularly when a single tanner must apply powder to many clients each day.

The inconsistency in powder application using traditional methods may also lead to variations in the final tan appearance. Areas with excess powder may appear lighter or patchy, while areas with insufficient powder may remain tacky or prone to streaking. This variability in results may lead to customer dissatisfaction and the need for touch-ups or reapplication.

Moreover, the time-consuming nature of conventional powder application methods may impact the overall efficiency of spray tanning services. Salons may need to allocate additional time for each client to accommodate the manual powder application process, potentially limiting the number of clients that can be served in a given time period.

Additionally, the use of traditional powder application methods may limit the ability of mobile spray tanning businesses to provide efficient services in various locations. The need for multiple tools and extended drying times may complicate the setup and breakdown process for mobile technicians, potentially reducing their ability to serve multiple clients in different locations efficiently.

In addition to the challenges mentioned previously, conventional spray tanning processes may face issues related to product waste and environmental impact. For example, manual application of drying powder using brushes or other tools may result in excessive powder being dispersed into the air or falling onto the floor. This may lead to unnecessary product waste and may require additional cleaning efforts, potentially increasing the overall cost of the tanning service.

Furthermore, the inconsistent application of drying powder using traditional methods may contribute to uneven absorption of the tanning solution. Areas with insufficient powder coverage may remain damp for longer periods, potentially leading to streaking or uneven coloration. This may result in client dissatisfaction and may necessitate additional touch-up sessions, further increasing resource consumption and environmental impact.

The manual nature of conventional powder application methods may also limit the ability to customize the amount of powder applied based on individual client needs. Different skin types and environmental conditions may require varying amounts of drying powder for optimal results. However, traditional application techniques may not provide the level of control needed to achieve this customization efficiently.

Moreover, the time-consuming process of manual powder application may extend the overall duration of a spray tanning session. This may lead to increased energy consumption for lighting, ventilation, and climate control in tanning facilities. The extended session times may also result in higher water usage for cleaning and maintenance between clients.

Additionally, the use of traditional powder application methods may pose challenges for clients with mobility issues or physical limitations. The need to stand still for extended periods during manual powder application may be uncomfortable or impractical for some individuals, potentially limiting their access to spray tanning services.

In some cases, the manual application of drying powder may also create difficulties in achieving consistent results across different technicians. The technique and skill level of individual operators may vary, leading to inconsistencies in powder application and potentially affecting the overall quality and repeatability of the spray tanning service.

Furthermore, there is a need for a solution that addresses the challenges associated with conventional spray tanning processes and manual powder application methods. Such a solution may improve overall efficiency, consistency, and hygiene in the spray tanning industry. It may also enhance client comfort and satisfaction while reducing environmental impact and resource consumption. A more effective approach to applying drying powder after spray tanning may potentially streamline salon operations, accommodate a wider range of clients, and provide more predictable, high-quality results across different technicians and environments.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In some embodiments, an apparatus for applying drying powder after a spray tan may comprise a main body configured to receive pressurized air from an air source. The apparatus may include a powder reservoir attached to the main body and configured to hold drying powder. An internal channel within the main body may be configured to direct air flow from the external air source to the powder reservoir. The apparatus may have a nozzle attached to the main body and configured to deliver a mixture of air and drying powder. A trigger mechanism may be configured to control air flow through the internal channel.

The apparatus may further comprise a quick-connect attachment configured to connect the main body to the external air source. An extension tube may extend into the powder reservoir and may be configured to direct air flow to a bottom portion of the powder reservoir. The internal channel may comprise a right-angle bend to redirect air flow from a first direction to a second direction. A removable diffuser may be attached to the nozzle and may be configured to refine a spray pattern of the mixture of air and drying powder. The powder reservoir may be transparent to allow visual inspection of powder levels.

A system for applying drying powder after a spray tan may comprise an air source configured to provide pressurized air. The system may include a hose connected to the air source. A powder applicator gun may be connected to the hose. The powder applicator gun may comprise a main body, a powder reservoir attached to the main body, an internal air channel within the main body, a nozzle attached to the main body, and a trigger mechanism. The powder applicator gun may be configured to receive pressurized air from the air source through the hose. The powder applicator gun may mix the pressurized air with drying powder from the powder reservoir. The powder applicator gun may dispense a mixture of air and drying powder through the nozzle when the trigger mechanism is actuated.

The air source may comprise a high volume low pressure (HVLP) turbine. The hose may comprise a quick-connect attachment for connecting to the powder applicator gun. The powder applicator gun may further comprise an extension tube extending into the powder reservoir and may be configured to direct air flow to a bottom portion of the powder reservoir. The internal air channel may comprise a right-angle bend to redirect air flow from a first direction to a second direction. The powder applicator gun may further comprise a removable diffuser attached to the nozzle and may be configured to refine a spray pattern of the mixture of air and drying powder.

A method of applying drying powder after a spray tan may comprise connecting a powder applicator gun to an external air source. The method may include filling a powder reservoir of the powder applicator gun with drying powder. The method may involve directing the powder applicator gun towards a user's skin. The method may include actuating a trigger mechanism on the powder applicator gun to allow pressurized air from the external air source to flow through an internal channel of the powder applicator gun, mix the pressurized air with the drying powder in the powder reservoir, and dispense a mixture of air and drying powder through a nozzle of the powder applicator gun onto the user's skin. The method may involve moving the powder applicator gun to cover desired areas of the user's skin. The method may include releasing the trigger mechanism to stop the flow of the mixture of air and drying powder.

The method may include connecting the powder applicator gun to the external air source by attaching a quick-connect fitting on the powder applicator gun to a corresponding fitting on a hose connected to the external air source. The method may involve directing the pressurized air through an extension tube within the powder reservoir to mix the air with the drying powder at a bottom portion of the powder reservoir. The method may include redirecting the flow of pressurized air within the powder applicator gun through a right-angle bend in the internal channel. The method may involve attaching a removable diffuser to the nozzle of the powder applicator gun to refine a spray pattern of the mixture of air and drying powder.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a perspective view of a powder applicator gun consistent with the present disclosure;

FIG. 2 illustrates a side view of the powder applicator gun;

FIG. 3 illustrates a cross-sectional view of the powder applicator gun; and

FIG. 4 is a flow chart of a method for utilizing the powder applicator gun.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of a powder applicator gun, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

The powder applicator gun is a novel device designed to efficiently apply drying powder after a spray tan treatment. This innovative apparatus may address a common challenge in the spray tanning industry by providing a quick and hygienic method for applying powder to freshly tanned skin. The powder applicator gun may connect to existing spray tan machine turbine systems, utilizing the same hoses and quick-connect fittings as other spray tan applicators.

The powder applicator gun may comprise several key components working in concert to deliver a controlled mist of drying powder. A main body may house internal air channels and a valve mechanism. A powder reservoir, which may be a clear plastic cup, may attach to the main body and hold the drying powder. A trigger mechanism may control the release of powder when activated. The device may include a quick-connect fitting for attaching to standard spray tan hoses, allowing for easy integration with existing equipment. An extension tube may extend into the powder reservoir, directing air to the bottom of the container to efficiently lift and mix the powder particles. When the trigger is activated, pressurized air may flow through the internal channels, creating turbulence in the powder reservoir. This action may lift the powder particles and mix them with the airstream. The powder-air mixture may then be expelled through a nozzle in a controlled spray pattern.

The powder applicator gun may transform the post-spray tan drying process from a manual, time-consuming task to a quick, efficient, and hygienic procedure. By utilizing pressurized air to dispense a fine, even layer of powder, the device may allow for full-body coverage in a matter of seconds. This efficiency may enable spray tan businesses to serve more clients and potentially improve customer satisfaction.

The design of the powder applicator gun may prioritize ease of use and effectiveness. The single trigger mechanism may provide simple operation, with no additional settings required. The clear powder reservoir may allow for visual inspection of powder levels. An optional diffuser attachment may be included to refine the spray pattern if desired.

The powder applicator gun may operate in spray tanning salons, mobile spray tanning businesses, and for in-home tanning systems sold to consumers. It may be used as the final step in the spray tanning process, after liquid tanning solutions have been applied. The device may connect to existing low-pressure air compressor systems (HVLP turbines) used for spray tanning, utilizing the same hoses and quick-connect fittings as other spray tan applicators.

The operating environment may include an enclosed room where spray tanning is performed. The powder applicator gun may be designed to dispense a light dusting of powder efficiently while avoiding excessive powder dispersion in the enclosed space.

The system may comprise an air source configured to provide pressurized air, such as an HVLP turbine. A hose may connect the air source to the powder applicator gun. The gun may attach to the hose via a quick-connect fitting for easy swapping with other spray tan applicators.

The powder applicator gun may be designed to work with existing spray tanning infrastructure and workflows. It may allow technicians and individuals to quickly apply drying powder as the final step, improving efficiency compared to manual powder application methods.

The device may be configured for professional salon use, mobile spray tanning service use, and/or use with in-home spray tanning machines and devices sold directly to consumers. For mobile use and in-home consumer use, a compact air source may potentially be integrated into the gun itself.

The operating environment may require the gun to dispense powder in a controlled manner to avoid excessive airborne particles. The nozzle and internal components may be engineered to produce an optimal spray pattern for even, light powder coverage on the skin.

Embodiments of the present disclosure may comprise methods, systems, and an apparatus comprising various components including, but not limited to, at least one of the following:
A. A Main Body
B. A Powder Reservoir
C. A Trigger Mechanism
D. A Nozzle
E. A Quick-Connect Fitting
F. An Air Source

In some embodiments, the present disclosure may provide an additional set of components that include, but not be limited to:
G. A Diffuser Attachment

Details with regards to each component are provided below. Although components are disclosed with specific functionality, it should be understood that functionality may be shared between components, with some functions split between components, while other functions duplicated by the components. Furthermore, the name of each component should not be construed as limiting upon the functionality of the component. Moreover, each component disclosed can be considered independently, without the context of the other components. Each component may contain functionality defined in other portions of this specification.

The following depicts an example of a method of a plurality of methods that may be performed by at least one of the aforementioned components. Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein. The method may comprise the following stages:
connecting a powder applicator gun to an air source;
filling a powder reservoir of the powder applicator gun with drying powder;
directing the powder applicator gun towards a user's skin;
actuating a trigger mechanism on the powder applicator gun to:
   allow pressurized air from the external air source to flow through an internal channel of the powder applicator gun;
   mix the pressurized air with the drying powder in the powder reservoir; and
   dispense a mixture of air and drying powder through a nozzle of the powder applicator gun onto the user's skin;
moving the powder applicator gun to cover desired areas of the user's skin; and
releasing the trigger mechanism to stop the flow of the mixture of air and drying powder.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

The powder applicator gun may address a technical problem in the spray tanning industry related to efficiently applying drying powder after a spray tan treatment. Traditional methods of manually applying powder with brushes or ad-hoc techniques can be time-consuming, messy, and potentially unhygienic. The powder applicator gun may provide a solution by allowing for quick, controlled, and hygienic application of drying powder.

In one example, the powder applicator gun may connect to existing spray tan turbine systems commonly found in tanning salons. This may allow the device to leverage equipment already present, reducing barriers to adoption. The gun may receive pressurized air from the turbine through a quick-connect fitting, directing the air through internal channels to a powder reservoir.

When activated via a trigger mechanism, the pressurized air may flow through an extension tube into the powder reservoir, creating turbulence that lifts and mixes powder particles into the airstream. This mixture of air and powder may then be expelled through a nozzle in a fine, controlled mist. The design may allow for rapid coverage of large body areas in seconds, significantly reducing application time compared to manual methods.

In another example, the powder applicator gun may be configured as a standalone unit with a built-in air source, such as a small electric fan or pump. This configuration may be particularly suitable for mobile spray tanning services or individual consumers. The self-contained design may allow for portability and use without connection to external air compressors.

The powder applicator gun may also be used in other contexts beyond spray tanning where controlled powder application is desired. For instance, it may potentially be adapted for applying cosmetic powders, dry shampoos, or other body powders in beauty and personal care applications. The ability to quickly and evenly apply powder without direct skin contact may have hygiene benefits in various scenarios.

The operating environment for enabling embodiments of the present disclosure may include a spray tanning facility. The spray tanning facility may comprise one or more spray tanning rooms. Each spray tanning room may be configured to accommodate a client receiving a spray tan treatment.

The spray tanning room may include an air compressor system. The air compressor system may be a high volume low pressure (HVLP) turbine configured to provide pressurized air for spray tanning equipment. The air compressor system may be connected to a hose with a quick-connect fitting at its end.

The spray tanning room may also include multiple spray applicator guns that may be interchangeably connected to the hose via the quick-connect fitting. These spray applicator guns may include a prep solution gun, a tanning solution gun, a post-spray liquid gun, and a powder applicator gun according to embodiments of the present disclosure.

The powder applicator gun may comprise a main body, a powder reservoir, and a trigger mechanism. The main body may be configured to receive pressurized air from the air compressor system through the hose and quick-connect fitting. The powder reservoir may be attached to the main body and may be configured to hold drying powder. The trigger mechanism may be configured to control the flow of air and powder through the powder applicator gun.

The spray tanning room may further include a client area where a client may stand to receive the spray tan treatment. The client area may be positioned at an appropriate distance from where a spray tan technician may operate the various spray applicator guns.

In operation, the powder applicator gun may be used as the final step in the spray tanning process. After applying liquid tanning solutions using the other spray applicator guns, the technician may connect the powder applicator gun to the hose via the quick-connect fitting. The technician may then use the powder applicator gun to apply a fine mist of drying powder to the client's skin, allowing for quick drying and enabling the client to dress shortly after the tanning process.

The powder applicator gun may provide an efficient solution for applying drying powder after a spray tan treatment. The powder applicator gun may comprise a main body that may be configured to receive pressurized air from the air compressor system via the hose and quick-connect fitting. The main body may house internal air channels that may direct the pressurized air flow.

The powder applicator gun may include a powder reservoir attached to the main body. The powder reservoir may be configured to hold drying powder and may be transparent to allow visual inspection of powder levels. An extension tube may extend into the powder reservoir and may be configured to direct air flow to a bottom portion of the powder reservoir.

A trigger mechanism may be incorporated into the powder applicator gun. The trigger mechanism may comprise a trigger button and an internal valve. When the trigger button is actuated, the internal valve may open to allow pressurized air to flow through the internal channels of the main body and into the powder reservoir.

The powder applicator gun may further include a nozzle attached to the main body. The nozzle may be configured to deliver a mixture of air and drying powder. A removable diffuser may be optionally attached to the nozzle to refine the spray pattern of the powder-air mixture.

In operation, a spray tan technician may connect the powder applicator gun to the hose using the quick-connect fitting. The technician may fill the powder reservoir with an appropriate amount of drying powder. When the trigger mechanism is actuated, pressurized air may flow through the internal channels and into the powder reservoir. The air flow may create turbulence in the powder reservoir, mixing the drying powder with the air. This mixture may then be expelled through the nozzle as a fine, controlled mist.

The technician may direct the powder applicator gun towards the client's skin in the client area. By moving the gun in smooth motions, the technician may quickly cover desired areas of the client's body with a light dusting of drying powder. This application method may allow for efficient coverage of large body areas in a matter of seconds, potentially reducing the time required for the post-spray tan drying process.

The powder applicator gun may improve upon manual powder application methods by providing a more controlled and hygienic approach. The gun may eliminate the need for direct skin contact or the use of brushes, potentially enhancing the overall cleanliness of the spray tanning process.

The powder applicator gun may provide several technical advantages over traditional methods of applying drying powder after a spray tan treatment. The powder applicator gun may allow for rapid coverage of large body areas in seconds, significantly reducing application time compared to manual methods like brushes or ad-hoc techniques. This increased speed may enable spray tanning businesses to serve more clients in less time. The gun design may provide more controlled and targeted powder application compared to manual methods. The nozzle and optional diffuser may allow for fine-tuning of the spray pattern to achieve optimal coverage.

By eliminating the need for direct skin contact or use of brushes, the powder applicator gun may enhance the overall cleanliness and hygiene of the spray tanning process. This may be particularly beneficial in commercial settings with multiple clients. Moreover, the mechanical nature of the powder applicator gun may allow for more consistent powder application across different technicians and sessions compared to manual techniques that rely heavily on individual skill. The controlled spray mechanism may also help to minimize excess powder dispersal compared to manual shaking or dusting methods, potentially reducing product waste and airborne particles in the tanning environment.

The powder applicator gun may be adaptable for use with different types of drying powders or in various contexts beyond spray tanning where controlled powder application is desired. This versatility may expand its potential applications and market. The gun design may reduce physical strain on technicians compared to repetitive manual powder application, potentially improving comfort during extended use. The quick and efficient powder application process may improve overall client satisfaction by reducing the time required for post-spray tan drying and allowing clients to dress and leave the salon more quickly.

By connecting to standard spray tanning air compressor systems, the powder applicator gun may leverage equipment already present in tanning salons, reducing barriers to adoption and additional equipment costs. The ability to adjust airflow or add attachments like diffusers may allow technicians to customize the powder application for different client needs or preferences.

The powder applicator gun may connect to existing spray tan air turbine systems that may already be present in tanning salons and mobile spray tanning services. This compatibility with standard equipment may allow for seamless integration into existing workflows without requiring significant additional investment. The device may utilize the same quick-connect fittings and hoses used with other spray tan applicators, potentially enabling technicians to switch between different application tools efficiently during a tanning session.

The powder applicator gun may comprise a main body with internal air channels, a powder reservoir, a trigger mechanism, and a nozzle. When a technician or user actuates the trigger, pressurized air from the connected air source may flow through the internal channels and into the powder reservoir via an extension tube. This tube may direct the air to the bottom of the reservoir, creating turbulence that may lift and mix the drying powder with the airstream. The resulting powder-air mixture may then be expelled through the nozzle as a fine, controlled mist.

This mechanical approach to powder application may offer several advantages over traditional manual methods. The gun may allow for rapid coverage of large body areas in seconds rather than minutes, potentially increasing the number of clients that may be served in a given time period. The controlled spray mechanism may provide more consistent powder distribution compared to manual techniques that may rely heavily on individual skill. By eliminating direct skin contact or the use of brushes, the powder applicator gun may enhance overall hygiene in the spray tanning process, which may be particularly beneficial in commercial settings with multiple clients.

The design of the powder applicator gun may prioritize user-friendly operation. The single trigger mechanism may provide simple control, while the transparent powder reservoir may allow for easy visual monitoring of powder levels. An optional diffuser attachment may be included to refine the spray pattern if desired, offering flexibility in application techniques.

Beyond its primary use in spray tanning salons, the powder applicator gun may also be valuable for mobile spray tanning services, and/or for in-home products for use by consumers. The device may potentially be adapted for other contexts where controlled powder application may be desired, such as applying cosmetic powders, dry shampoos, or other body powders in beauty and personal care applications.

The powder applicator gun 100 may be designed for easy disassembly and cleaning. The powder reservoir 114 may be removed from the main body 102 for emptying and cleaning between uses. The nozzle 124 and optional diffuser attachment 128 may also be removable for maintenance purposes.

Regular cleaning and maintenance of the powder applicator gun 100 may help ensure consistent performance and longevity of the device. Proper care may include removing any powder residue from the internal components and ensuring that the trigger mechanism 118 and internal valve 122 remain free from powder buildup that could affect operation.

The powder applicator gun 100 may be adaptable for use with different types of drying powders based on client needs or preferences. The design may accommodate various powder formulations without requiring modifications to the device itself, providing flexibility for salon operators.

In addition to its primary use in spray tanning applications, the powder applicator gun 100 may potentially be adapted for other contexts where controlled powder application is desired. These applications may include applying cosmetic powders, dry shampoos, or other body powders in beauty and personal care settings.

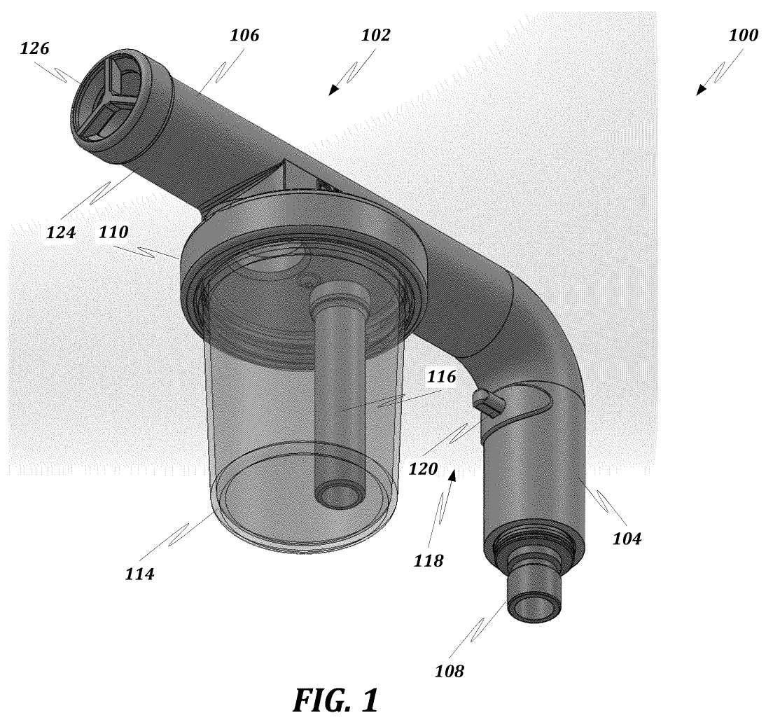

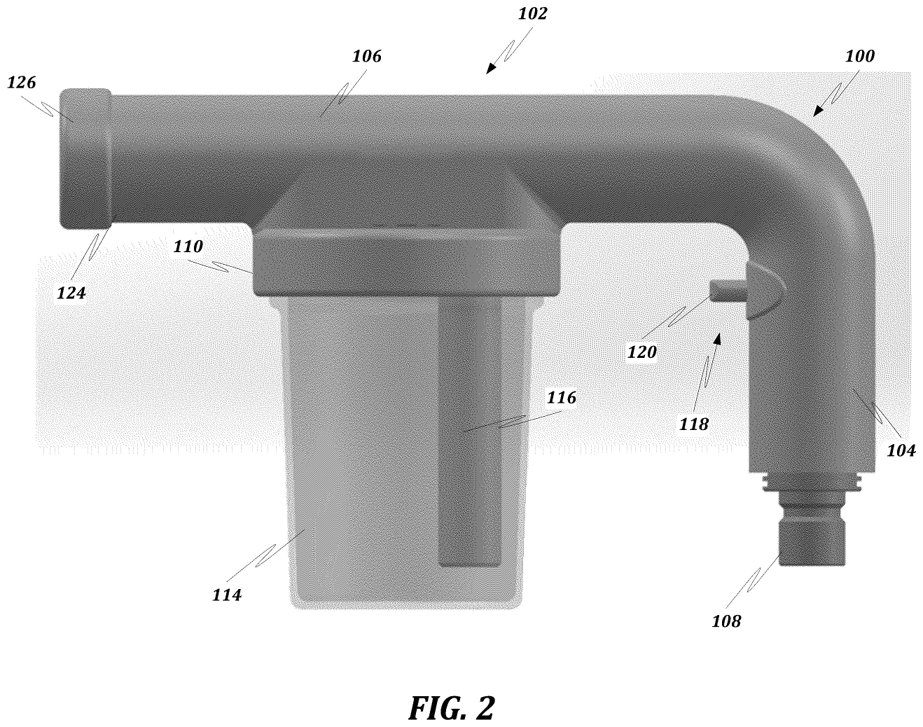

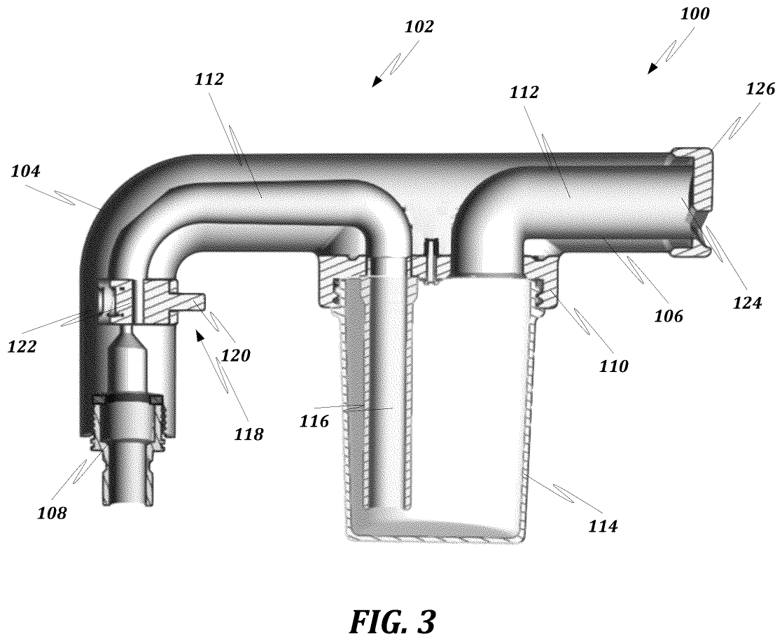

As shown in FIGS. 1-3, a powder applicator gun 100 may include components, such as, but not limited to:

### A. A Main Body

The powder applicator gun 100 may comprise a main body 102 having a proximal section 104 and a distal section 106. The proximal section 104 may be configured as a handle or grip portion for a user to hold the applicator gun 100, while the distal section 106 may be positioned at approximately a right angle relative to the proximal section 104. This configuration may allow for ergonomic handling and effective directing of the powder spray toward the target area.

The main body 102 may be constructed from lightweight, durable materials such as impact-resistant plastics. These materials may be selected to withstand regular use in salon environments while remaining comfortable for extended handling by technicians. The main body 102 may house internal air channels 112 that may direct the flow of pressurized air through the device.

The main body 102 may be configured to receive pressurized air from an external air source. The main body 102 may be formed substantially in the shape of a gun, having a first (proximal) section 104 and a second (distal) section 106. The proximal section 104 may incorporate a grip to facilitate operation by a user, such as a spray tan operator. The distal section 106 may be disposed at an approximately right angle relative to the proximal section 104, helping to direct the output of the application gun 100 towards the target (e.g., a spray tan client). In embodiments, the main body 102 may be formed from relatively lightweight and durable materials, such as plastics.

In some embodiments, a quick-connect fitting 108 may be attached to the main body 102 at a base of the application gun 100. The quick-connect fitting 108 may be configured to connect the powder applicator gun 100 to a hose from the external air source. This may allow for easy attachment to and/or detachment from standard spray tanning equipment. This fitting 108 may allow for seamless integration with existing salon infrastructure. The quick-connect fitting 108 may incorporate an industry-standard connection mechanism compatible with high volume low pressure (HVLP) turbine systems commonly used in spray tanning.

The main body 102 may incorporate a connection point 110 for connecting to the powder reservoir 114. The connection point 110 may include a mating interface for selectively receiving and retaining the reservoir. For example, the mating interface may be formed as a threaded interface, a friction fit interface, and/or the like. In some embodiments, the connection point 110 may incorporate an O-ring and/or gasket to help create a substantially air-tight seal between the main body 102 and the powder reservoir. The connection point 110 is preferably disposed along the distal portion 106 of the main body 102.

The main body 102 may include internal air channels 112 to facilitate and direct the flow of fluid (e.g., pressurized air). At least one of the internal air channels 112 within the main body 102 may include a right-angle bend. This bend may redirect air flow from a first direction to a second direction as it travels through the powder applicator gun 100 (e.g., flowing through the proximal portion 104 into the distal portion 106). As one particular example, the one or more air channels 112 may include a first air channel that directs air from the quick connect 108 to the connection point 110 (e.g., through the proximal portion 104 and a part of the distal portion 106), and a second air channel that directs air from the connection point 110 through the remainder of the distal portion 106 to a distal end of the main body 102.

The internal air channels 112 within the main body 102 may include at least one right-angle bend to redirect air flow from the proximal section 104 into the distal section 106. This configuration may allow pressurized air to enter through the quick-connect fitting 108, travel through the handle portion, and then be redirected toward the nozzle 124 and powder reservoir 114. The internal channels 112 may be designed to minimize turbulence and pressure loss while maintaining adequate air flow.

In some alternative embodiments, the powder applicator gun 100 may be configured with various modifications to enhance functionality and adaptability across different use scenarios. The main body 102 may be constructed from different materials, such as lightweight aluminum alloys, carbon fiber composites, or antimicrobial plastics to provide enhanced durability or hygiene benefits. The main body 102 may also be designed with different ergonomic profiles to accommodate various hand sizes or to reduce operator fatigue during extended use sessions.

### B. A Powder Reservoir

The applicator gun 100 may comprise a powder reservoir 114. The powder reservoir 114 may be attached to the main body 102 of the powder applicator gun 100. The powder reservoir 114 may be configured to hold drying powder and/or other powders for application. For example, the application may be after a spray tan. The powder reservoir 114 may be constructed from transparent plastic material to allow visual monitoring of powder levels during operation. This transparency may enable operators to determine when refilling is necessary without needing to disconnect the reservoir. The powder reservoir 114 may have a capacity optimized for multiple applications before refilling is required.

The powder reservoir 114 may removably attach to the main body 102, allowing for refilling or replacement as needed. A connection mechanism may secure the powder reservoir 114 to the main body 102 while maintaining a substantially airtight seal. This connection may allow pressurized air to flow from the main body 102 into the powder reservoir 114.

An extension tube 116 may extend from the main body 102 into the powder reservoir 114. The extension tube 116 may be configured to direct air flow to a bottom portion of the powder reservoir 114, creating turbulence that effectively lifts and mixes the drying powder with the airstream. The extension tube 116 may be positioned to maximize powder dispersion and minimize areas where powder may accumulate or become trapped.

The powder reservoir 114 may have a capacity sufficient for multiple applications before refilling is required. The capacity may be optimized to balance portability with reduced refill frequency. In some embodiments, graduations or fill lines may be included on the powder reservoir 114 to assist in measuring powder quantities.

The shape of the powder reservoir 114 may be designed to promote efficient powder flow and minimize areas where powder may accumulate or become trapped. For example, in some embodiments, a bottom surface of the reservoir may have a slightly conical or funnel-shape to help direct powder towards the air stream from the extension tube 116. This design may enhance the efficiency of powder utilization and provide more consistent application results.

The powder reservoir 114 may be offered in multiple sizes to accommodate different usage requirements. For high-volume salon environments, a larger capacity reservoir may be provided, while a smaller, more compact reservoir may be available for mobile spray tanning services. The powder reservoir 114 may also be designed with different shapes, such as a wider, shorter profile or a taller, narrower profile, depending on the specific application needs and user preferences.

In some embodiments, the powder reservoir 114 may include measurement markings or graduation lines to help operators measure precise amounts of powder for different application scenarios. The reservoir 114 may also feature a funnel-shaped interior bottom to direct powder toward the air stream from the extension tube 116, potentially improving powder utilization and reducing waste.

Alternative embodiments of the extension tube 116 may include different configurations to optimize powder mixing and dispersion. The extension tube 116 may be adjustable in length to accommodate different powder reservoir sizes or to modify the powder mixing dynamics. In some embodiments, the extension tube 116 may include multiple air outlets or specialized patterns of perforations to create different turbulence patterns within the powder reservoir 114.

### C. A Trigger Mechanism

The applicator gun 100 may comprise a powder reservoir 118. The trigger mechanism 118 may comprise a trigger button 120 and an internal valve 122. The trigger button 120 may be positioned on the exterior of the proximal portion 104 of the main body 102 for easy access by an operator's finger. The internal valve 122 may be located within the main body 102 and may be operatively connected to the trigger button 120. The trigger button 120 may be ergonomically positioned on the exterior of the proximal section 104 for easy access by the operator's finger during use. The button 120 may feature a textured or rubberized surface to prevent finger slippage during operation.

When the trigger button 120 is actuated (e.g., depressed) by an operator, it may cause the internal valve 122 to open. This may allow pressurized air to flow through the internal air channel 112 of the main body 102. When the trigger button 120 is released, the internal valve 122 may close, stopping the air flow.

The internal valve 122 may be a simple on/off valve that fully opens or closes based on trigger actuation. Additionally or alternatively, the valve 122 may allow for variable flow control depending on how far the trigger button 120 is pressed.

The trigger mechanism 118 may include a spring or other biasing mechanism to automatically close the valve 122 when the trigger 120 is released. This may provide a fail-safe to stop powder flow when not actively triggered.

The internal components of the trigger mechanism 118 may be sealed to prevent powder infiltration. This may help ensure reliable long-term operation in a powder-filled environment.

The trigger mechanism 118 may be designed for easy disassembly and cleaning. This may allow for periodic maintenance to remove any powder buildup on internal components.

The trigger mechanism 118 may be offered in various configurations to suit different user preferences and operational requirements. In some embodiments, the trigger mechanism 118 may include a variable flow control feature that adjusts the air flow rate based on how far the trigger button 120 is pressed. This may allow for more precise control over powder application intensity. In other embodiments, the trigger mechanism 118 may include a locking feature that keeps the valve 122 open without requiring continuous pressure on the trigger button 120, which may be beneficial for large-area applications.

### D. A Nozzle

In embodiments, the applicator gun 100 may include a nozzle 124. The nozzle 124 may be disposed at a distal end of the distal portion 106. The nozzle may be removably and/or adjustably attached to the main body 102 of the powder applicator gun 100.

The nozzle 124 may be configured to output a mixture of air and drying powder from the one or more inner air channel 112 of the gun 100. The nozzle 124 may help to shape and/or other regulate the powder spray pattern as it exits the device 100. The nozzle 124 may be positioned at the front (distal) end of the main body 102, opposite the air inlet.

The nozzle 124 may include an opening sized and shaped to produce an appropriate spray pattern for applying powder evenly over the body. In some embodiments, the nozzle 124 may be angled slightly downward to facilitate aiming the powder spray at the user's skin. In some embodiments, the nozzle may be adjustable to allow the operator to modify the spray pattern. As one non-limiting example, adjustment of the nozzle may control a width of the spray pattern, allowing for adjustment of the coverage area.

The nozzle 124 may be constructed from materials that can withstand repeated use and cleaning, with a smooth interior to promote laminar flow of the powder-air mixture. As non-limiting examples, the nozzle may be formed from plastic, metal, and/or other suitable materials that can withstand repeated use and cleaning. An exterior of the nozzle may be textured or shaped to provide grip for the user when handling the device and to allow for easy adjustment of the nozzle.

The nozzle 124 may be designed to deliver a controlled mixture of air and drying powder from the internal air channels 112. The opening of the nozzle 124 may be sized and shaped to produce an appropriate spray pattern for even powder application over the body. In some embodiments, the nozzle 124 may be slightly angled downward to facilitate aiming the powder spray at the client's skin.

The nozzle 124 may be available in different designs to create various spray patterns. Some nozzle 124 designs may produce a wider, more diffuse spray pattern suitable for covering large body areas quickly, while others may create a more focused, concentrated spray for detailed work or smaller body areas. The nozzle 124 may also be adjustable in some embodiments, allowing the operator to modify the spray pattern without changing components.

### E. A Quick-Connect Fitting

The quick-connect fitting 108 may be attached to the main body 102 at a base of the application gun 100. The quick-connect fitting 108 may be configured to connect the powder applicator gun 100 to a hose from the external air source. This may allow for easy attachment to and/or detachment from standard spray tanning equipment.

The quick-connect fitting 108 may comprise a female socket portion configured to receive a corresponding male plug portion from the hose of the external air source. The female socket portion may include an internal locking mechanism that may engage with the male plug portion when inserted. This locking mechanism may provide a secure connection while maintaining an airtight seal to prevent air leakage during operation.

The quick-connect fitting 108 may be constructed from durable materials such as metal alloys or high-strength polymers to withstand repeated connections and disconnections. The materials may be selected to resist corrosion and wear over time, ensuring reliable performance throughout the operational life of the powder applicator gun 100.

In some embodiments, the quick-connect fitting 108 may incorporate an O-ring or gasket to enhance the airtight seal between the fitting and the hose connection. This sealing element may help maintain consistent air pressure during operation, which may be important for achieving uniform powder distribution.

The quick-connect fitting 108 may be designed to be compatible with industry-standard HVLP (High Volume Low Pressure) spray tanning equipment connections. This standardization may allow the powder applicator gun 100 to be used with existing spray tanning infrastructure without requiring additional adapters or modifications.

The connection mechanism of the quick-connect fitting 108 may be designed for one-handed operation, allowing technicians to quickly switch between different spray applicators during a tanning session. The mechanism may include a push-button or collar-style release that may be easily operated while wearing gloves or with wet hands.

In some embodiments, the quick-connect fitting 108 may include a swivel joint that may allow the hose to rotate freely without twisting or kinking during use. This feature may enhance maneuverability and reduce strain on the operator's wrist when applying powder to different areas of the client's body.

The quick-connect fitting 108 may be positioned at an angle that may optimize ergonomics and balance of the powder applicator gun 100 when connected to the hose. This positioning may help reduce operator fatigue during extended use sessions.

The interface between the quick-connect fitting 108 and the main body 102 may be designed to transfer air efficiently with minimal pressure loss. The internal passage may be smooth and appropriately sized to maintain adequate air flow while preventing turbulence that could affect powder distribution.

In some embodiments, the quick-connect fitting 108 may include a check valve that may prevent backflow of powder into the hose when the trigger mechanism 118 is released. This feature may help maintain cleanliness of the air supply system and prevent cross-contamination between different powder types if multiple guns are used with the same air source.

The quick-connect fitting 108 may be securely fastened to the main body 102 using methods such as threading, bonding, or mechanical fasteners to ensure it remains firmly attached during use. The connection point may be reinforced to withstand the stresses of repeated connections and disconnections without loosening over time.

In certain embodiments, the quick-connect fitting 108 may include visual indicators such as color coding or tactile features to help operators quickly identify the correct orientation for connection. These features may facilitate rapid equipment changes in busy salon environments.

The quick-connect fitting 108 may be designed with smooth external surfaces to prevent snagging on clothing or other objects during use. Any protruding elements may be minimized or protected to reduce the risk of damage when the gun is set down or stored between uses.

In some embodiments, the quick-connect fitting 108 may incorporate a filter element to trap any contaminants that might be present in the air supply before they enter the powder applicator gun 100. This filtration may help prevent clogging of internal components and ensure consistent performance.

The dimensions and specifications of the quick-connect fitting 108 may be precisely controlled during manufacturing to ensure consistent fit and function across all production units. This quality control may help maintain reliable connections regardless of which hose or air source is used with the powder applicator gun 100.

In some embodiments, the quick-connect fitting 108 may be designed to be compatible with different types of air supply systems beyond standard HVLP turbines. This may include adapters for different hose sizes or connection types to accommodate a wider range of existing equipment in various salon environments.

### F. An Air Source

An air source 126 for the powder applicator gun 100 may provide airflow through the gun to mix powder with the airflow and expel a powder-air mixture through the nozzle 124.

In some embodiments, the air source 126 may comprise a high volume low pressure (HVLP) turbine system. This type of air source may be commonly used in spray tanning applications. The HVLP turbine may provide a consistent flow of low pressure air that may be suitable for dispersing the fine powder particles. In other embodiments, the air source 126 may comprise a compressed air reservoir. For example, the air pressure provided by the source 126 may be in the range of 2-10 PSI, which may be sufficient to create a fine mist of powder without excessive dispersion. In still other embodiments, the air source 126 may comprise a fam or blower mechanism. There are many options for providing air to the applicator gun 100.

The air source 126 may connect to the powder applicator gun 100 via a flexible hose. The hose may have a quick-connect fitting on one end that may attach to the corresponding fitting 108 on the gun. This may allow for easy connection and disconnection of the air supply.

In some embodiments, the air source may provide air at a pressure between 2-10 PSI. This relatively low pressure may help create a fine mist of powder without excessive airborne particles. The air flow rate from the source 126 may be adjustable in some implementations to allow customization of the powder application.

The air source 126 may optionally include a filter to remove any moisture and/or contaminants from the air stream before it enters the powder applicator gun 100. This may help maintain consistent performance and avoid clumping of the powder.

In certain embodiments, the air source 126 may be portable, allowing for mobile spray tanning operations. Compact HVLP turbines designed specifically for spray tanning may be suitable for this purpose.

The air source 126 may include controls to adjust air pressure and/or flow rate. This may allow the operator to optimize the powder application for different body areas, powder types, and/or application locations.

For mobile spray tanning services or in-home use, some embodiments of the powder applicator gun 100 may include a built-in air source 126 rather than requiring connection to an external HVLP turbine. This self-contained design may incorporate a small electric fan or pump within the main body 102 or as an attached module, potentially powered by batteries or a small AC adapter. This configuration may allow for greater portability and use in locations without access to external air compressor systems.

For mobile applications, the air source 126 may be a portable HVLP turbine specifically designed for spray tanning operations. These compact systems may allow for mobile spray tanning services while maintaining the functionality of the powder applicator gun 100.

In operation, the powder applicator gun 100 may be connected to the air source 126 via the quick-connect fitting 108. The powder reservoir 114 may be filled with an appropriate amount of drying powder. When the operator actuates the trigger mechanism 118 by pressing the trigger button 120, pressurized air may flow through the internal channels 112 and into the powder reservoir 114 via the extension tube 116.

The air flow may create turbulence in the powder reservoir 114, lifting and mixing the drying powder with the air. This mixture may then be expelled through the nozzle 124 as a fine, controlled mist. If the optional diffuser attachment 128 is installed, it may further refine the spray pattern for optimal coverage.

The operator may direct the powder applicator gun 100 toward the client's skin, moving it in smooth motions to cover desired areas with a light dusting of drying powder. This application method may allow for efficient coverage of large body areas in seconds, significantly reducing the time required for the post-spray tan drying process compared to manual methods.

When sufficient coverage has been achieved, the operator may release the trigger button 120, causing the internal valve 122 to close and stopping the flow of the powder-air mixture. The quick-connect fitting 108 may allow for easy disconnection from the air source 126 when the application is complete.

### G. A Diffuser Attachment

In some embodiments, the nozzle 124 may include an optional diffuser attachment 128. The diffuser attachment 128 may be removable and/or adjustable. In some embodiments, the diffuser attachment 128 may be configured to refine and/or adjust the spray pattern of the powder-air mixture. The diffuser attachment 128 may be removably coupled to the nozzle 124 of the powder applicator gun 100. In some embodiments, the diffuser attachment 128 may comprise a conical or flared shape that extends outward from the nozzle 124. The diffuser attachment 128 may be configured to spread or disperse the powder-air mixture as it exits the nozzle 124.

The diffuser attachment 128 may be formed from a plastic, metal, or other suitable material. In certain implementations, the diffuser attachment 128 may be transparent or translucent to allow visual inspection of powder flow. The diffuser attachment 128 may attach to the nozzle 124 via a friction fit, threaded connection, snap-fit, or other removable coupling mechanism.

In some embodiments, the diffuser attachment 128 may include internal baffles, channels, or other flow-directing features. These internal features may help to further refine the spray pattern and distribution of the powder-air mixture. The size, shape, and configuration of the diffuser attachment 128 may be optimized for different powder types or application needs.

The diffuser attachment 128 may allow for adjustment of the spray pattern width. In some implementations, the diffuser attachment 128 may be rotatable or otherwise adjustable to vary the spray pattern from a narrow, focused stream to a wider dispersed mist. This adjustability may allow the operator to optimize powder application for different body areas or client preferences.

In certain alternative embodiments, the diffuser attachment 128 may be offered in multiple designs with different internal structures to create various spray patterns. Some diffuser attachments 128 may include internal baffles or flow-directing features that may help to create more uniform powder distribution or specialized application patterns. The diffuser attachment 128 may also be made from different materials, including transparent or translucent materials to allow visual monitoring of powder flow.

### H. Alternative Embodiments

Alternative embodiments may also include specialized features for professional salon environments, such as a hanging hook or stand to store the powder applicator gun 100 when not in use. Some versions may include a cleaning mode that runs air through the system without powder to clear residual powder from internal components between uses.

For environments where different types of powders may be used, some embodiments may include interchangeable powder reservoirs 114 that can be quickly swapped to switch between different powder formulations without requiring cleaning between changes. These reservoirs 114 may be color-coded or labeled to help operators identify the contents quickly.

In certain embodiments, the powder applicator gun 100 may incorporate antimicrobial materials in components that come into contact with powder or that may be touched by multiple operators. This feature may enhance hygiene in commercial salon environments where the device may be used with multiple clients.

Some alternative embodiments may include a powder level sensor within the powder reservoir 114 that may provide a visual or audible indication when powder levels are running low. This feature may help prevent interruptions during application sessions and ensure consistent results.

The internal air channel 112 may be designed with different configurations in various embodiments to optimize air flow dynamics and powder mixing. Some designs may incorporate multiple channels or specialized geometries to create ideal turbulence patterns for different powder types or application scenarios.

In certain embodiments, the powder applicator gun 100 may include a filter element positioned within the air flow path to prevent any moisture or contaminants from the air source 126 from entering the powder reservoir 114. This may help maintain consistent powder flow and prevent clumping of the drying powder.

For salon environments with multiple operators, some embodiments may offer personalized components such as trigger grips or nozzle configurations that can be quickly swapped to accommodate individual preferences while maintaining the core functionality of the device.

In alternative embodiments designed for specialized applications, the powder applicator gun 100 may be configured to work with different types of powders beyond standard spray tan drying powders. This may include cosmetic powders, dry shampoos, or other body powders used in beauty and personal care applications.

Some embodiments may include a heating element that may slightly warm the air flow to enhance the drying effect of the powder application. This feature may be particularly beneficial in humid environments where additional drying capability may be desirable.

For professional salon use, certain embodiments may include a digital control system that may allow operators to save and recall specific settings for different client needs or preferences. This system may control parameters such as air flow rate or spray pattern configuration.

Alternative embodiments may also incorporate different connection mechanisms between the main body 102 and the powder reservoir 114. These may include bayonet mounts, magnetic connections, or other quick-release mechanisms designed to allow for rapid reservoir changes while maintaining a secure, airtight seal during operation.

In some embodiments, the powder applicator gun 100 may feature modular construction that allows for easy disassembly for thorough cleaning and maintenance. Components may be designed to be dishwasher-safe or easily sanitized using standard salon cleaning products.

For specialized applications requiring precise powder application, certain embodiments may include a distance guide attachment that helps operators maintain the optimal distance between the nozzle 124 and the client's skin for consistent results.

Alternative embodiments may also be designed with sustainability considerations, potentially incorporating recycled materials in construction or designing components to be easily recyclable at the end of the product lifecycle.

In some embodiments, the powder applicator gun 100 may include a soft-start feature that gradually increases air flow when the trigger mechanism 118 is first actuated. This may help prevent sudden bursts of powder and allow for more controlled application, particularly at the beginning of the application process.

For environments where multiple powder applicator guns 100 may be in use simultaneously, certain embodiments may include distinctive visual elements or color schemes to help operators quickly identify specific units.

Some alternative embodiments may incorporate sound-dampening features to reduce operational noise, which may enhance the client experience in salon environments. These features may include specialized materials in the main body 102 or internal baffling to reduce air flow noise.

In certain embodiments designed for high-volume salon use, the powder applicator gun 100 may feature wear-resistant materials at key contact points to extend the operational lifespan of the device under heavy usage conditions.

Alternative embodiments may also include specialized accessories such as extension wands that may allow operators to more easily reach difficult areas such as the back or lower legs without requiring awkward positioning.

For training purposes, some embodiments may include a practice mode that may use reduced air flow or specialized indicators to help new operators learn proper application techniques without wasting product or affecting client results.

In certain alternative embodiments, the powder applicator gun 100 may be designed to accommodate both right-handed and left-handed operators with ambidextrous controls or adjustable components that can be configured for comfortable use by either hand.

Some embodiments may incorporate visual indicators that show when the device is ready for use, such as indicator lights that confirm proper connection to the air source 126 or adequate air pressure for optimal operation.

Alternative embodiments may also include specialized storage solutions, such as a custom case or stand that holds the powder applicator gun 100 and associated accessories while protecting them from damage or contamination between uses.

For salon environments with specific aesthetic themes, the powder applicator gun 100 may be available in different color schemes or decorative finishes while maintaining the same functional capabilities.

In some embodiments designed for mobile spray tanning services, the powder applicator gun 100 may include a compact, collapsible design that allows for easier transportation between client locations.

Alternative embodiments may also incorporate different textures or materials on grip surfaces to enhance operator comfort and control during extended use sessions, potentially reducing hand fatigue and improving application precision.

### III. PLATFORM OPERATION

The method of applying drying powder after a spray tan may be performed by one or more actors, including but not limited to spray tan technicians, clients, salon operators, mobile spray tanning service providers, and/or individual consumers. The actors performing the method may vary depending on the particular implementation, environment, and use case scenario.

The various stages of the method may be rearranged, combined, separated, or performed in different sequences than those explicitly described herein without departing from the scope of the method. Additional stages may be added, certain stages may be omitted, and the relative order of stages may be modified while still achieving the fundamental objectives of the method.

The method may be performed in various environments, including but not limited to spray tanning salons, mobile spray tanning settings, home environments, and other locations where spray tanning services are provided. The specific environment in which the method is performed may influence the particular manner in which the stages are executed, but the fundamental aspects of the method remain applicable across different settings.

The stages of connecting a powder applicator gun to an air source, filling a powder reservoir, directing the gun towards a user's skin, actuating a trigger mechanism, moving the gun to cover desired areas, and releasing the trigger mechanism may be performed in a continuous sequence or with pauses between stages as appropriate for the particular application scenario. The method may be repeated multiple times for different clients or for different body areas of the same client.

The method may be adapted for different types of powder products beyond drying powder, and may be performed using various configurations of powder applicator guns that operate on the same fundamental principles described herein. The method may also be modified to accommodate different air source configurations, including but not limited to external HVLP turbines, portable air compressors, or self-contained air sources integrated into the applicator gun itself.

In some implementations, portions of the method may be automated or assisted by mechanical, electronic, or computational means, while still maintaining the essential characteristics of the method as described herein.

### A. Master Method

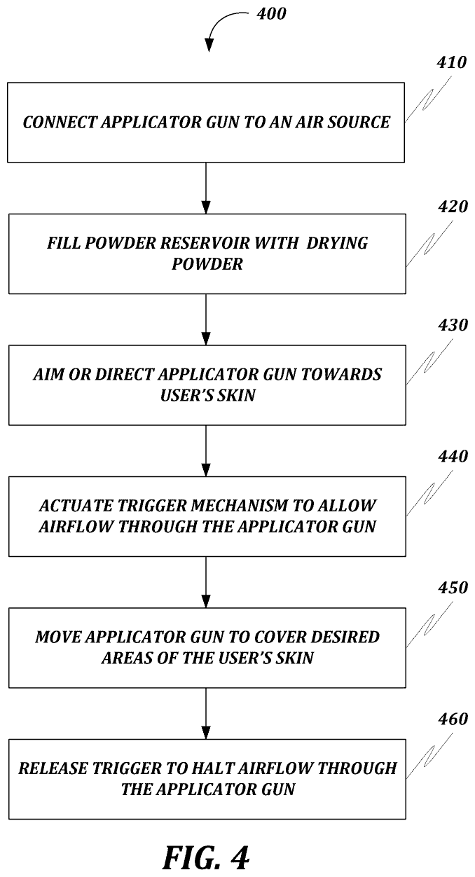

Consistent with embodiments of the present disclosure, a method may be performed by or with at least one of the aforementioned components. FIG. 4 is a flow chart setting forth the general stages involved in a method 400 consistent with an embodiment of the disclosure for providing and using the powder applicator gun 100.

Method 400 may begin at stage 410 where a powder applicator gun 100 may be connected to an air source 126. The connection may be established via a quick-connect fitting 108 on the powder applicator gun 100 that may attach to a corresponding fitting on a hose from the air source 126. The quick-connect fitting 108 may allow for easy attachment and detachment from standard spray tanning equipment. This connection may create a pathway for pressurized air to flow from the air source 126 into the internal channels 112 of the main body 102 of the powder applicator gun 100.

In one embodiment, the air source 126 may be a high volume low pressure (HVLP) turbine system commonly used in spray tanning applications. The HVLP turbine may provide a consistent flow of low pressure air in the range of 2-10 PSI, which may be suitable for dispersing fine powder particles without creating excessive airborne dust. In another embodiment, the air source 126 may be a portable compressor that may be particularly suitable for mobile spray tanning services.

From stage 410, the method may advance to stage 420 where a powder reservoir 114 of the powder applicator gun 100 may be filled with drying powder. The powder reservoir 114 may be temporarily detached from the main body 102 to facilitate filling. The transparent material of the powder reservoir 114 may allow for visual confirmation of appropriate powder levels. In some embodiments, the powder reservoir 114 may include graduation marks or fill lines to assist in measuring powder quantities. After filling, the powder reservoir 114 may be reattached securely to the main body 102, ensuring a substantially airtight seal at the connection point 110.

The drying powder used in this stage may be specially formulated for post-spray tan application. The powder may be finely milled to allow for smooth flow through the applicator gun 100 and even distribution on the skin. Various types of drying powders may be used based on client preferences and/or specific skin requirements.

Once the powder reservoir 114 has been filled with drying powder in stage 420, the method may continue to stage 430 where the powder applicator gun 100 may be directed towards a user's skin. The user may be a client who has just received a spray tan treatment. The operator may hold the powder applicator gun 100 by the proximal section 104 of the main body 102, which may be designed as a grip or handle. The distal section 106 of the main body 102, which may be positioned at approximately a right angle relative to the proximal section 104, may be pointed towards the target area of the user's skin.

In some embodiments, the operator may maintain a distance of approximately 6-12 inches between the nozzle 124 of the powder applicator gun 100 and the user's skin. This distance may allow for appropriate dispersal of the powder-air mixture and even coverage on the skin. The slightly downward angle of the nozzle 124 may facilitate aiming the powder spray at the user's body while maintaining a comfortable position for the operator.

After directing the powder applicator gun 100 towards the user's skin in stage 430, the method may proceed to stage 440 where a trigger mechanism 118 on the powder applicator gun 100 may be actuated. The actuation may involve pressing a trigger button 120 with the operator's finger. When the trigger button 120 is pressed, it may cause an internal valve 122 to open, allowing pressurized air from the air source 126 to flow through the internal channels 112 of the main body 102.

The pressurized air may flow through the extension tube 116 and into the powder reservoir 114. The air flow may be directed to the bottom portion of the powder reservoir 114, creating turbulence that lifts and mixes the drying powder with the airstream. This mixing action may transform the static powder into a dynamic powder-air mixture. The powder-air mixture may then be channeled through the internal passages of the main body 102 and expelled through the nozzle 124 as a fine, controlled mist.

In some embodiments, a diffuser attachment 128 may be coupled to the nozzle 124 to further refine the spray pattern of the powder-air mixture. The diffuser attachment 128 may help to create a wider, more dispersed spray pattern for covering larger body areas efficiently, or a more focused pattern for detailed work on smaller areas.

From stage 440, the method may advance to stage 450 where the powder applicator gun 100 may be moved to cover desired areas of the user's skin. The operator may use smooth, sweeping motions to apply an even layer of drying powder across the user's body. The movement may be continuous and methodical to ensure complete coverage without over-application in any one area.

The operator may start with larger body areas such as the back, chest, abdomen, and legs, using broader sweeping motions. For smaller or more contoured areas such as the face, neck, hands, and feet, the operator may use more controlled, precise movements. The transparent powder reservoir 114 may allow the operator to monitor powder levels during application, ensuring sufficient powder remains for complete coverage.

In some embodiments, the operator may adjust their technique based on client feedback and visual assessment of the powder application. The speed of movement, distance from the skin, and angle of application may all be modified to achieve optimal results for different body areas and client preferences.

Once the desired areas of the user's skin have been covered with drying powder in stage 450, the method may conclude at stage 460 where the trigger mechanism 118 may be released to stop the flow of the mixture of air and drying powder. When the trigger button 120 is released, the internal valve 122 may close, immediately halting the air flow through the internal channels 112 and stopping the powder dispensing action.

After completing the application process, the operator may disconnect the powder applicator gun 100 from the air source 126 by detaching the quick-connect fitting 108. In some embodiments, the operator may perform maintenance tasks such as emptying any remaining powder from the powder reservoir 114 and cleaning the components to prepare for the next use.

The method described above may transform the post-spray tan drying process from a manual, time-consuming task to a quick, efficient, and hygienic procedure. By utilizing pressurized air to dispense a fine, even layer of powder, the method may allow for full-body coverage in a matter of seconds rather than minutes required by traditional manual application methods.

In an alternative embodiment of the method, the operator may adjust the air pressure from the air source 126 before connecting the powder applicator gun 100. Different air pressure settings may be selected based on the specific requirements of the application, such as the type of drying powder being used or the preference for lighter or heavier powder coverage.

In another embodiment, the method may include an additional stage where the operator attaches or adjusts a diffuser attachment 128 to the nozzle 124 before directing the powder applicator gun 100 towards the user's skin. The selection of a particular diffuser attachment 128 may be based on the specific body area being treated or the desired spray pattern characteristics.

The method may also be adapted for self-application, where the user operates the powder applicator gun 100 themselves to apply drying powder to accessible areas of their own body. In this scenario, the design of the powder applicator gun 100, with its ergonomic grip and intuitive trigger mechanism 118, may facilitate easy self-application.

For mobile spray tanning services, the method may be performed using a portable air source 126 that can be easily transported between client locations. The quick-connect fitting 108 may allow for rapid setup and breakdown of the equipment, enhancing the efficiency of mobile operations.

The method may also be applicable in contexts beyond spray tanning where controlled powder application may be desired. For instance, it may potentially be adapted for applying cosmetic powders, dry shampoos, or other body powders in beauty and personal care applications.

### IV. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. An apparatus for applying drying powder after a spray tan, the apparatus comprising:
a main body configured to receive pressurized air from an air source;
a powder reservoir attached to the main body and configured to hold drying powder;
an internal channel within the main body configured to direct air flow from the external air source to the powder reservoir;
a nozzle attached to the main body and configured to deliver a mixture of air and drying powder; and
a trigger mechanism configured to control air flow through the internal channel.

2. The apparatus of claim 1, further comprising:
a quick-connect attachment configured to connect the main body to the external air source.

3. The apparatus of claim 1, further comprising:
an extension tube extending into the powder reservoir and configured to direct air flow to a bottom portion of the powder reservoir.

4. The apparatus of claim 1, wherein the internal channel comprises a right-angle bend to redirect air flow from a first direction to a second direction.

5. The apparatus of claim 1, further comprising:
a removable diffuser attached to the nozzle and configured to refine a spray pattern of the mixture of air and drying powder.

6. The apparatus of claim 1, wherein the powder reservoir is transparent to allow visual inspection of powder levels.

7. The apparatus of claim 1, wherein the trigger mechanism comprises:
a trigger button; and
an internal valve configured to open when the trigger button is actuated and close when the trigger button is released.

8. A system for applying drying powder after a spray tan, the system comprising:
an air source configured to provide pressurized air;
a hose connected to the air source; and
a powder applicator gun connected to the hose, the powder applicator gun comprising:
a main body;
a powder reservoir attached to the main body;
an internal air channel within the main body;
a nozzle attached to the main body; and
a trigger mechanism;
wherein the powder applicator gun is configured to:
receive pressurized air from the air source through the hose;
mix the pressurized air with drying powder from the powder reservoir; and
dispense a mixture of air and drying powder through the nozzle when the trigger mechanism is actuated.

9. The system of claim 8, wherein the air source comprises a high volume low pressure (HVLP) turbine.

10. The system of claim 8, wherein the hose comprises a quick-connect attachment for connecting to the powder applicator gun.

11. The system of claim 8, wherein the powder applicator gun further comprises:
an extension tube extending into the powder reservoir and configured to direct air flow to a bottom portion of the powder reservoir.

12. The system of claim 8, wherein the internal air channel comprises a right-angle bend to redirect air flow from a first direction to a second direction.

13. The system of claim 8, wherein the powder applicator gun further comprises:
a removable diffuser attached to the nozzle and configured to refine a spray pattern of the mixture of air and drying powder.

14. The system of claim 8, wherein the powder reservoir is transparent to allow visual inspection of powder levels.

15. A method of applying drying powder after a spray tan, the method comprising:
connecting a powder applicator gun to an external air source;
filling a powder reservoir of the powder applicator gun with drying powder;
directing the powder applicator gun towards a user's skin;
actuating a trigger mechanism on the powder applicator gun to:
allow pressurized air from the external air source to flow through an internal channel of the powder applicator gun;
mix the pressurized air with the drying powder in the powder reservoir; and
dispense a mixture of air and drying powder through a nozzle of the powder applicator gun onto the user's skin;
moving the powder applicator gun to cover desired areas of the user's skin; and
releasing the trigger mechanism to stop the flow of the mixture of air and drying powder.

16. The method of claim 15, wherein connecting the powder applicator gun to the external air source comprises:
attaching a quick-connect fitting on the powder applicator gun to a corresponding fitting on a hose connected to the external air source.

17. The method of claim 15, further comprising:
directing the pressurized air through an extension tube within the powder reservoir to mix the air with the drying powder at a bottom portion of the powder reservoir.

18. The method of claim 15, further comprising:
redirecting the flow of pressurized air within the powder applicator gun through a right-angle bend in the internal channel.

19. The method of claim 15, further comprising:
attaching a removable diffuser to the nozzle of the powder applicator gun to refine a spray pattern of the mixture of air and drying powder.

20. The method of claim 15, wherein actuating the trigger mechanism comprises:
pressing a trigger button to open an internal valve within the powder applicator gun, allowing pressurized air to flow through the internal channel.
